(19) United States
(12) Patent Application Publication
(10) Pub. No.: US 2010/0288881 A1
(43) Pub. Date: Nov. 18, 2010

(54) SECURED COCKPIT HAVING AN INTEGRATED ACCOMMODATION AREA AND LAVATORY FACILITIES

(75) Inventors: Felix Helfrich, Hamburg (DE); Thomas Sütthoff, Hamburg (DE); Jovan Ulbrich-Gasparevic, Pinneberg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: AIRBUS OPERATIONS GMBH, Hamburg (DE)

(21) Appl. No.: 12/675,238

(22) PCT Filed: Aug. 13, 2008
(86) PCT No.: PCT/EP2008/060612

§ 371 Date: Jun. 11, 2010

Related U.S. Application Data
(60) Provisional application No. 60/967,004, filed on Aug. 31, 2007.

(30) Foreign Application Priority Data
Aug. 31, 2007 (DE) 102007041391.4

(51) Int. Cl. B64D 11/00; B64D 11/02

(52) U.S. Cl. 244/118.6

(57) ABSTRACT

The invention relates to a work and accommodation module for providing a cockpit and for accommodating at least one pilot of an aircraft. To this end, the work and accommodation modules have a work area and a accommodation area, wherein the work area contains all equipment for controlling and piloting the airplane. The accommodating area contains at least one element, selected from the group consisting of a rest area and lavatory facilities. In addition, the module is separated from a passenger area by at least one security partition.

### RELATED APPLICATIONS

The present invention claims the priority of U.S. Provisional Patent Application No. 60/976,004, submitted on Aug. 31, 2007, and German Patent Application No. 2007 041 391.4, submitted on Aug. 31, 2007, the content of which is referenced herein.

### FIELD OF THE INVENTION

The present invention relates to work and accommodation rooms for pilots in airplanes. In particular, the present invention relates to a work and accommodation module for providing a cockpit and for accommodating at least one pilot of an aircraft, an aircraft with a corresponding module, and the use of a corresponding module in an aircraft.

### TECHNICAL BACKGROUND

Accommodation rooms (lounge rooms) for pilots of an aircraft (flight crew, as opposed to cabin crew, which is responsible for serving the passengers: cabin crew), also referred to as flight crew rest compartment (FCRC), are included on the prescribed list of mandatory equipment on airplanes for long flights. International standards require that one reclining option be provided for flights lasting from 8 to 14 hours, and that two reclining options be provided for flights lasting over 14 hours. The background for this requirement has to do with the fact that a total of two alternating cockpit crews must be on board starting at a specific flight duration.

Security requirements on aircraft have been tightened significantly in the last few years, as a result of which the most recent official requirements state that the cockpit door and the cockpit wall integrated into airplanes must be bulletproof modules. It might also become necessary for pilots to have direct spatial access to the FCRC from the cockpit, without having to enter into the passenger area.

Known cockpits reflecting the current state of the art comprise as a work area “working area” seats for two pilots, a third seat (third occupant seat), and an optional additional fourth seat, along with a complete set of equipment for controlling the aircraft. In the past, the cockpit doors including the cockpit wall was integrated into the airplanes as a bulletproof module.

In addition, known solutions are often not optimally configured in terms of cabin comfort for the pilots, since there is no room to move around within the secured area.

U.S. Pat. No. 7,156,344 B1 discloses a long-range aircraft with a private cabin for the pilots, which is situated in a lower area of the aircraft, preferably below the cockpit.

### SUMMARY OF THE INVENTION

The object of the present invention is to provide for an improved work and accommodation module for providing a cockpit and for accommodating at least one pilot of an aircraft.

A work and accommodation module for providing a cockpit and for accommodating at least one pilot of an aircraft, an aircraft exhibiting such a module, and the use of such a module in an aircraft according to the independent claims are indicated.

Other embodiments of the invention may be gleaned from the dependent claims.

One exemplary embodiment of the invention provides for a work and accommodation area for providing a cockpit and for accommodating at least one pilot of an aircraft. The work and accommodation module here exhibits a work area and accommodation area, wherein the work area contains all equipment for controlling and guiding the aircraft. Therefore, the work and accommodation module according to the invention comprises of a complete cockpit of an aircraft, in addition to a accommodation area. The accommodation or lounge area in turn consists either of a rest area, lavatory facilities, or both mentioned elements. In addition, the entire module is separated from the area of the aircraft accessible to passengers by at least one security partition. From a security standpoint, the specification here encompasses at least one of the following properties: bulletproof, entry-proof, fireproof, access-proof and explosion proof.

In addition, the module exhibits a work area at a first vertical height, wherein at least one element from the lounge area or at least one component of an element from the lounge area is arranged at a second vertical height of the aircraft, and wherein this first vertical height is at the same or lower level of the second vertical height.

As a result of the work and accommodation module according to the invention, which is composed of a secured cockpit (flight deck) with integrated accommodation or rest area and toilet or lavatory facilities (lavatory), the actual cockpit now no longer needs to be secured by a door, but can rather be closed by means of curtains, for example. A wide variety of configurations is possible within the cockpit (flight deck), provided that they realize the important aspect of always protecting the cockpit crew (flight crew) against forced entry by undesired third parties, for example terrorists. This provides the crew with a high level of security.

Integrating the lavatory area and rest area, for example of a flight crew rest compartment, into the actual cockpit makes it possible to preclude any contact between the passengers and cockpit crew during the flight. This yields a protected sleeping area for the crew inside the former cockpit, a protected area that allows the crew to use the bathroom and take care of all other human necessities in lavatory facilities. Given a simultaneous increase in comfort and freedom to move around inside the secure area, all contact with passengers can also be avoided during the long-range flight. In addition to addressing security aspects, the work and accommodation module also results in an upgrade to the workplace with respect to comfort and freedom of movement for the entire cockpit crew.

Inside the accommodation area according to the invention, the rest area can be used, for example in the form of a known or conventionally used work and accommodation module (flight crew rest compartment), which in turn is integrated as a module into the work and accommodation module. The module here contains a sleep area with one or more reclining options, wherein reclining options can include any arrangement that allows an individual to assume a reclined resting and sleeping position. While the reclining unit can here take the form of a simple foam pad, special structural designs that permit a comfortable, longer period of reclined resting are also possible. In particular, the configuration can consist of beds, loungers, plank beds, foldout beds, collapsible beds, and any other type of reclining unit. In each exemplary embodiment of the present invention, variants of a folding bed can here offer in particular the capability of being used as a table or tray when folded together. If only one part of the bed is folded down, the remaining part of the bed can also be used as a stowage compartment or pigeonhole. In addition, the folding bed variant makes it possible to gain surface area, and hence increase freedom of movement, by folding down the unit.

In addition, the rest area can provide one or more sitting options for the cockpit crew, wherein any seat configurations are possible, including a folding seat, aircraft seat, passenger seat, business class seat and high comfort cabin attendant seat, as well as a TTL seat (taxi, takeoff and landing seat).

In addition, a sleeping area may also be present inside the accommodation area, which is separated from the rest of the work area by some form of separating walls. It is here entirely possible for the sleeping area to be separated from the rest of the accommodation area by a height difference, wherein the height difference can in this instance be surmounted by additional steps, meaning generally a climbing aid.

In addition to the mandatory outfitting of aircraft with a sufficient number of sleeping options for the crewmembers, a module with a rest area for the cockpit crew offers considerably more flexibility and possible configurations for the crewmembers during the rest and relaxation times. This tangibly increases the overall comfort of the module. In order to enable a continued independent use of the module according to the invention by the cockpit crew during the entire flight time, all security equipment, for example fire extinguishers, are located inside the module, so that the module according to the invention need never be exited during the flight under any circumstances.

To provide enough storage space for the baggage and wardrobe of the cockpit crew, various stowage compartments are integrated in the accommodation area. However, wall cabinets, normal cabinets or sideboard compartments can also be installed.

The work area and accommodation area can definitely be separated by spatially partitioning elements within the module according to the invention, which need not completely satisfy the stringent security requirements placed on the outer wall of the module toward the passenger area. For example, the two areas can be separated by installing a curtain, or even just a higher blind.

By contrast, the area encompassing the lavatory facilities may include a toilet, a washroom, a bidet, a shower or individual sinks. Everything the cockpit crew needs even during a long-range flight for purposes of bodily hygiene and covering human hygiene requirements is here present in the area of lavatory facilities.

In order to ensure that the cockpit crew is provided with enough food and beverages, these semi-luxuries can be processed and packaged in the module according to the invention in such a way that the cockpit crew can satisfy its eating and drinking needs without any support by the remaining crew, and without any action involving the unsecured area. However, it is also possible for the security partition that separates the module according to the invention with its two areas from the rest of the passenger area to be designed in such a way that it enables a device for serving food and beverages that does not influence the security protection of the separating wall in any way. For example, the serving hatch can here be configured as a security transfer tube with multiple doors. This security partition, which will be described in more detail in an exemplary embodiment below, can exhibit a door, and hence access from the module according to the invention into the passenger area, but also a configuration of the security partition without any connection to the passenger area (meaning neither a door nor a serving hatch are present). In order that the cockpit crew can enter into the module, a separate entry from the outside environment of the aircraft into the module according to the invention is provided. In comparison to normally constructed walls inside an aircraft, the security partition has at least one of the following characteristics relative to the passenger area: bulletproof, entry-proof, fireproof, access-proof and explosion proof.

Therefore, the module according to the invention is indeed realized in such a way that, for example, a bed of the rest area is secured at a vertical height above or below the work area. This can be a space-saving measure that provides storage space in the process of optimizing space or also while minimizing the invasion by the module into the passenger area. For example, the bed can here be arranged both in the longitudinal and transverse direction above or below the work area and above or below the remaining lounge area. However, any other element from the lounge area or at least a component of an element from the lounge area, such as a toilet, a bidet or a sitting option, can be fixed in place below the cockpit level. This does not preclude an inclusion of the crown area (ceiling area within the main deck) of the aircraft or the freight room below the cockpit. In any potential configuration variant of the module according to the invention where individual elements or components of the elements can be arranged at different vertical heights, the only crucial factor is that the partition from the passenger area satisfy the aforementioned security standards over the entire vertical height and depth.

Let it further be generally noted that a component of an element refers to those things that are part of an element or form an element.

In another exemplary embodiment of the present invention, the module according to the invention exhibits a climbing aid in the accommodation area and/or work area to either connect the work area with the accommodation area, or join elements of the accommodation area.

If the accommodation area is located entirely at a vertical height different than that of the work area, climbing aid for ascending and descending into the accommodation area must be present to simplify access for the cockpit crew. In this case, the climbing aid can be any mechanical device that enables ascent from a lower plane into a plane situated above it, and vice versa. Specifically, this climbing aid can be a staircase, a ladder, a single step or even a shoulder that allows ascent. However, cases where only part of the accommodation area is to be situated at a vertical height other than that of the work area also necessitate such a climbing aid. The module according to the invention provides for such a climbing aid.

In another exemplary embodiment of the invention, the rest area of the module exhibits at least one element selected form a group comprised of a sitting option and table.

Integrating a sitting option can further increase the comfort and flexibility of the module according to the invention. A crewmember located in the module according to the invention is not essentially forced to lie down, but can rather freely decide on a lounging position suited to his or her individual preference at the time. This results in a pleasant lounging experience in the module. In addition, this further increases the level of comfort. Integration also enhances comfort significantly so as to expand the possible range of activities for a crewmember in the module.

In addition, the module according to the invention can incorporate a sitting option from a group comprised of a folding seat, aircraft seat, passenger seat, business class seat, and high comfort cabin attendant seat as well as TTL seat (taxi, takeoff and landing seat), specifically in the rest area of the module (e.g., in an integrated flight crew rest compartment).

To enable the greatest possible flexibility in adjusting to individual wishes on the one hand while also being able to offer a maximum level of comfort on the other, for example, this sitting option can be realized in different ways. On the one hand, a folding seat can be installed. The basic functional requirement of providing a sitting option is here realized to the full extent. However, there are other advantages inherent in the increased available space that can be provided by an optional folding seat with folded seating surface or also with folded backrest or support, if on hand. Folded components can also assume other functions, for example by providing additional support and stowage areas.

In another exemplary embodiment of the present invention, the rest area of the module exhibits at least one sleeping option.

To ensure compliance with the list of mandatory equipment on aircraft during long-range flights, the module contains at least one sleeping option. International standards require that one sleeping option be provided for flights lasting from 8 to 14 hours, and that two sleeping options be provided for flights lasting over 14 hours. This also stems from the requirement that a total of two alternating cockpit crews must be on board starting at a specific flight duration. This implies that the module according to the invention might be subject to prolonged or uninterrupted use during the flight. The sleeping option or several sleeping options can here be arranged in the crown area of the aircraft, both longitudinally and transverse relative to the longitudinal direction of the aircraft. However, the module according to the invention also enables accommodating the sleeping option under the vertical height of the work area.

In addition, the sleeping option or reclining option or even a plurality thereof can be provided in both the longitudinal and transverse directions of the aircraft, and smaller or larger deviations from the rectangular orientation relative to the longitudinal axis are here further possible and permissible. Angling the reclining options might increase the surface available for lying down given confined spaces without unnecessarily enlarging the module according to the invention.

A reclining option lying transverse to the longitudinal axis of the aircraft further offers the advantage that a corresponding configuration projects less invasively into the aircraft area lying behind it. This avoids optical, functional and space-related difficulties during integration. As a result, the cabin area lying to the back can make use of the maximum height of the cabin, thereby creating additional space, for example for security equipment. In addition, it counteracts the elevated danger of a passenger hitting their head on the ceiling.

This applies both with respect to sleeping options and reclining options that are accommodated directly and independently of a possible additionally installed compartment within the module according to the invention, but also to those sleeping options or reclining options that are located in a crew rest compartment situated in the lounge area of the module according to the invention.

In another exemplary embodiment of the present invention, the lounge area of the module is accommodated on the freight deck level.

In this configuration of the invention, the complete lounge area including the rest area and lavatory facilities is located under the working plane on the freight deck level. The advantage to this is that the longitudinal extension of the module according to the invention along the longitudinal axis of the aircraft can be minimized, thereby diminishing the invasive extension of the module into the passenger area. In addition, it can be advantageous to design the lounge area as a smaller sub-module, which conforms to the shape and configuration of a conventional freight container at the freight deck level. Further advantages can be derived from the above in terms of simplifying the design relative to the shape of the container-like sub-module, along with its installation and integration into the freight deck environment by comparison to integration on the main deck level.

In another exemplary embodiment of the present invention, the module is separated from the passenger by a continuous wall with no door.

If the module according to the invention is to satisfy the highest possible security standards that can be placed on such a module relative to access security, the partition of the work and lounge module relative to the passenger area can be designed without any interruption whatsoever, such as a door or serving hatch. Hence, this partition wall with no opening and door offers the best possible protection against forced, intentional entry by intruders. In order to ensure normal access to the module for the cockpit crew in this exemplary embodiment of the present invention, a separate entrance not accessible from the normal passenger area within the aircraft is provided exclusively for the cockpit crew. For example, this separate entry into the module is situated further to the front relative to the longitudinal axis of the aircraft in comparison to the normal passenger entry. As a consequence, the cockpit crew enters the module from the runway via a separate aisle or gangway or even a separate stairway, giving it an entirely different access to the aircraft than the passengers. This represents the peak security stage for the crew during the entire flight.

In another exemplary embodiment of the present invention, the security partition consists of a layered structure that has at least one element selected from a group comprised of a first outer decorative front plate, an aramide layer, a hollow space, a honeycomb layer, a second outer decorative front plate, a bulletproof transition element and a ceiling for this transition element.

This security partition of the module according to the invention ensures that the partition will exhibit at least one of the following partition properties: be bulletproof, explosion proof, entry proof, fireproof and/or access proof.

The transition element serves to ensure that the corners, joints and areas where the partition switches to other materials or objects or abuts the latter exhibit at least one of the following properties: are bulletproof, explosion proof, entry-proof, fireproof and/or access proof. To this end, the transition element can consist of titanium, for example, or of other materials that satisfy the relevant criteria. The transition element is here adhesively bonded with the respective layer into which it is to be incorporated. At a high mechanical strength, the honeycomb layer offers a low weight by comparison to other materials, thereby making it possible to reduce the weight of such a partition.

The two decorative front plates need here only satisfy optical criteria, so that they can be made out of any conceivable materials, such as wood, plastic, wood applications or film. The partition wall is here to be tailored to its respective environment.

The cover of the transition element is made out of aluminum, for example, although other materials that can be optically tailored to the environment of the partition are also possible. The ceiling is here preferably to offer decorative characteristics. For this reason, a great variety of materials can be used in the basic design of the ceiling.

All used layers of the partition can here be adhesively bonded permanently over the entire surface. However, other attachment and production methods are also possible, such as screwing, compaction, and other possible combinations.

The thickness of the various layers must be selected based on the respective desired security standard. For example, the decorative front plates are 3.0 millimeters (mm) thick, the transition element 3.0 mm, the aramide layer 10.0 mm, and the honeycomb layer 19 mm. In this exemplary embodiment, a partition with an overall thickness of 38 mm would be the result.

In another exemplary embodiment of the present invention, the interior of the module is divided into compartments by partition elements, such as curtains, partition walls, room dividers, folding walls, partition screens, partition wall systems, room partition walls, cabins, partition wall units or blinds.

Since the module according to the invention is secured as an entire unit relative to the passenger area by security partition walls, materials that satisfy special security standards need not be used within the module for purposes of spatial separation. In comparison with two modules installed separately from each other that contain the two areas (work area and flight crew rest compartment) as known from previous solutions, this solution offers a weight advantage, since only one spatial unit has to be provided with security cladding or equipment relative to the passenger area. For example, the following figures show a curtain as a partition between the work and accommodation area. Since the module a compact unit secured from the remainder of the aircraft, no additional protective measures need be taken to avert potential attacks within the module. However, a configuration that provides an additional security barrier in the module itself is definitely possible.

Another exemplary embodiment of the present invention indicates the use of a corresponding module in an aircraft.

Another exemplary embodiment of the present invention indicates an aircraft with a module according to the present invention.

Additional exemplary embodiments and advantages of the invention may be gleaned from the following descriptions of the figures.

The depictions in the figures are schematic and not to scale.

### BRIEF DESCRIPTION OF THE FIGURES

FIG. 1 shows a diagrammatic, two-dimensional, vertical sectional view according to an exemplary embodiment of the present invention.

FIG. 2 shows a diagrammatic, two-dimensional, horizontal sectional view according to an exemplary embodiment of the present invention.

FIG. 3 shows a diagrammatic, two-dimensional, vertical sectional view according to an exemplary embodiment of the present invention.

FIG. 4 shows a diagrammatic, two-dimensional, horizontal sectional view according to an exemplary embodiment of the present invention.

FIG. 5 shows a diagrammatic, two-dimensional, vertical sectional view according to an exemplary embodiment of the present invention.

FIG. 6 shows a diagrammatic, two-dimensional, vertical sectional view through a partition wall according to an exemplary embodiment of the present invention.

### DETAILED DESCRIPTION OF PREFERRED EXEMPLARY EMBODIMENTS OF THE INVENTION

Preferred exemplary embodiments of the present invention will be described below with reference to the figures.

In the following description to the figures, the same reference numbers are used to refer to identical or similar elements.

The statements made here with regard to the module also apply with respect to an aircraft that exhibits a corresponding module, as well as to the use of a corresponding module in an aircraft.

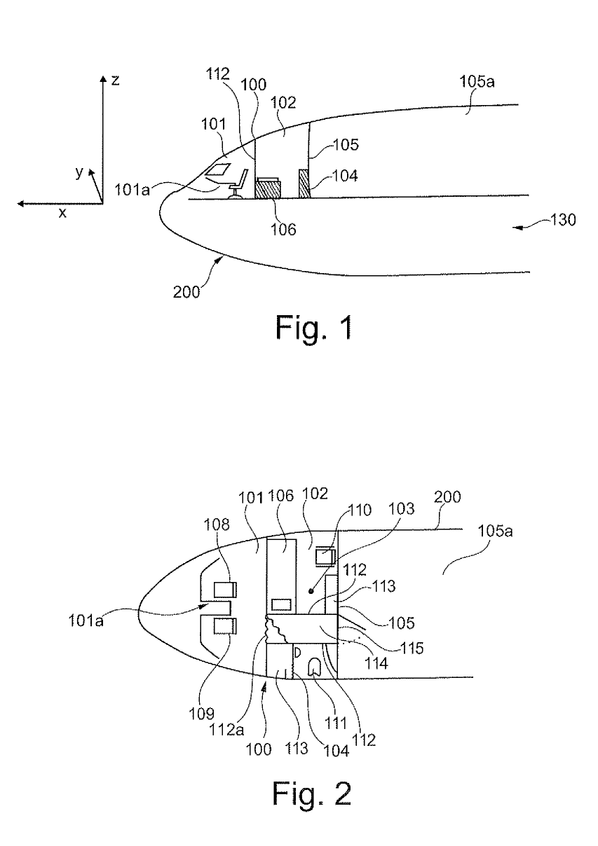

FIG. 1 shows a diagrammatic, two-dimensional sectional view of the work and accommodation module 100 according to the invention along the longitudinal axis of the aircraft 200, wherein the x-z plane is here visible. The two elements of the work and accommodation module, specifically the work area 101 that exhibits or comprises a cockpit 101a, and the accommodation or lounge area 102 are here clearly discernible. Since the module according to the invention is sealed, separated or partitioned from the unsecured area 105a by a security partition 105, no special partition that satisfies security relevant criteria need be provided within the module 100 according to the invention. Therefore, this partition 112 within the module can be a spatially separating element, such as a curtain, a partition wall, a room divider, a folding wall, a partition screen, entire partition wall systems, individual cabin walls, partition wall units or even just a simple blind.

The work area 101 oriented toward the top of the aircraft contains all equipment for controlling and piloting the aircraft. Hence, this completely equipped cockpit 101a allows the cockpit crew to have all necessary technical devices and accessories at its disposal within the work area for the entirety of however long a flight, so as to be able to independently, properly and completely control the aircraft 200 at any time of the flight and during takeoff and landing, and hence to fly and monitor said aircraft.

In order to avoid the necessity of contact with other people who are not part of the cockpit crew, the accommodation area 102 of the module according to the invention incorporates any and all objects required by the cockpit crew for purposes of resting, taking care of their hygiene needs, performing additional tasks and satiating any potential hunger and thirst. This exemplary embodiment of the present invention depicts an example for a sleeping option 106 and lavatory facilities 104. In this case, the term “sleeping option” is to be understood as any reclining opportunity that allows the cockpit crew to regenerate or rest during break periods. The lavatory facilities 104 can here exhibit a toilet, a washroom, one or more sinks with hot and cold running water, and a drain, or additionally a bidet or shower. In addition to upgrading the workplace and enhancing workplace comfort by integrating a rest area and lavatory facilities in this way, reflected not least in a greater freedom of movement within the secure area for the cockpit crew, it is vitally important that a protected area is created for the crew to sleep and go to the bathroom.

Also visible is the freight deck plane 130, into which the module according to the invention can extend if needed.

FIG. 2 shows a diagrammatic, horizontal sectional view of the module 100 according to the invention along the longitudinal axis of the aircraft 200 as viewed from above into the module according to the invention. As evident from this exemplary embodiment of the present invention, the security partition 105 that completely protects the secured flight deck with integrated rest area and lavatory relative to the unsecured area 105a can also incorporate a door 115 within this security partition 105.

However, depending on the desired security standard, the work and accommodation module according to the invention can indeed also provide for a security partition 105 that contains no opening like a door or gap, affording the greatest possible protection to the secured cockpit crew area with the accommodation area 102 and work area 101.

Should it be advantageous in terms of module use or the work schedule within the aircraft during a flight for the cabin crew to provide the cockpit crew with food and beverages, the door 115 shown here by example can be replaced by a gap or serving hatch to ensure secure service from the unsecured area into the module. This gap or serving hatch is here designed in such a way as not to diminish the characteristics of the protective security means 115 through the installation of this gap, i.e., keeping it bulletproof, entry-proof, fireproof, access-proof and explosion proof. It is here important that the characteristics of the protective means include at least one of the following: bulletproof, entry-proof, fireproof, access-proof and explosion proof. For example, an at least two-door transfer tube can be installed, which is mechanically and sometimes also electronically designed in such a way as to prevent both access and provision of objects not accepted by the cockpit crew via the security partition 105.

This exemplary embodiment of the present invention here denotes both elements of the accommodation area 102, specifically the rest area 103 and lavatory facilities 104. In this case, the lavatory facilities consist of a washroom with or without toilet, or only of a single toilet 111. Located next to the latter is a first storage area 113 that provides enough space for accommodating the required utensils of the cockpit crew.

The accommodation area 102 with a sitting option 110, a stowage compartment 113 and an exemplary configuration of a sleeping option 106 begins on the opposite side of the aircraft, behind an aisle 114. In addition, the aisle 114 in this exemplary embodiment of the present invention is separated from the work area by a partition within the module, here designed as a fluted curtain. As a result, an authorized person can pass through the door 115 in the security partition 105 and into the protected area, and hence into the module 100 according to the invention. Situated along the aisle 114 on the right and left sides are both the lounge area 103 along with the lavatory facilities 104, wherein the work area 101 begins at the end of the aisle after a partition within the module.

It is here depicted by example with a seat for the pilot and copilot 108, 109, and diagrammatically as a cockpit 101a. The essential factor here is that the work and accommodation module incorporate all equipment necessary for controlling and guiding the aircraft. This enables the cockpit crew to implement completely independent and autarchic guidance and control of the aircraft 200 over a flight of whatever duration, without having to have to leave the security zone in the module according to the invention. For example, the stowage compartments 113 can be used to store enough food and beverage supplies, and potentially to also provide ancillary means making it possible to prepare or heat these foodstuffs. In individual cases, it may also be important that all feed lines for whatever media, including water, fresh air, oxygen, electrical current or other liquids and gases needed for controlling the aircraft and depended upon by the crewmember of the flight crew within the module be configured in such a way as to prevent third persons from interrupting or influencing the supply of this medium through the lines during the flight. This yields a secured flight deck with integrated rest area and lavatory, which enables completely independent and autarchic operation for the cockpit crew.

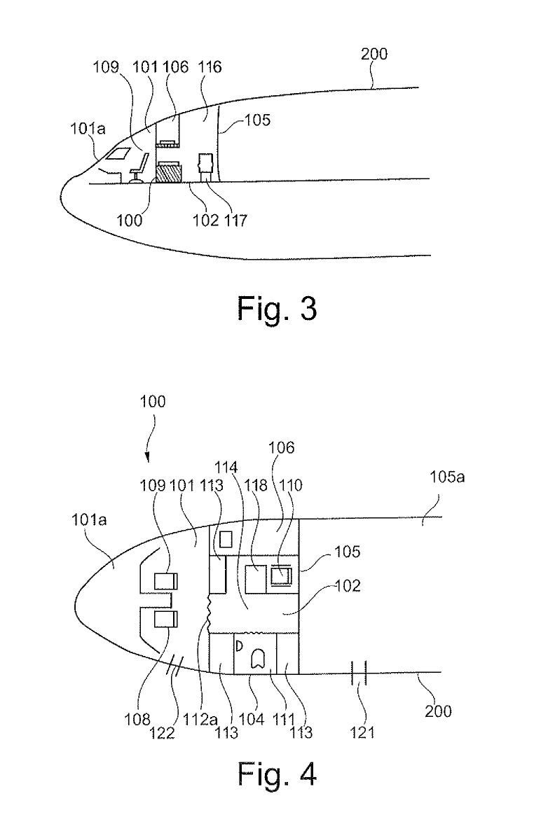

FIG. 3 shows a two-dimensional, diagrammatic sectional view along the longitudinal axis of the aircraft 200, and a further exemplary embodiment of the module 100 according to the invention. As clearly evident from this view, the accommodation area 102 can also accommodate a sleeping option 106 in the crown area of the cabin so as to satisfy certain space requirements or penetrate as little as possible into the unsecured area 105a lying behind the module. Also depicted in this exemplary embodiment is a business class seat 117, wherein the latter is shown as an example of any sitting option.

As also clearly evident from FIG. 3, the sleeping option 106 is arranged transverse to the longitudinal direction of the aircraft, making it possible to minimize the longitudinal expansion of the module according to the invention.

FIG. 4 shows a diagrammatic, two-dimensional, horizontal sectional view along the longitudinal axis of the aircraft 200, and encompasses a module 100 according to the invention. The work area 101 is here again configured with a cockpit 101a, meaning that it is provided with all equipment necessary for controlling and guiding the aircraft. It also accommodates a first and second seat 108 and 109 for the pilot and copilot. A curtain 112a separates the work area from the lounge area 102, wherein the lounge area again consists of a rest area 103 and lavatory facilities 104. Visible in the rest area 103 is a sleeping option parallel to the longitudinal axis of the aircraft, marked 106. Also present in the rest area are a sitting option 110 and a foldout table 118 and stowage compartments or a storage area 113.

However, another important factor relative to this figure is that the security partition 105 that separates the module from the unsecured area 105a located behind it has no opening whatsoever, like a door, gap or even transfer tube. Access to the maximum-security work and lounge module is now provided by an exclusive entry for the cockpit crew 122. As clearly evident from the figure, the entry for the passengers and cabin crew 121 is situated further back toward the tail of the aircraft as viewed on the longitudinal axis of the aircraft. As a result, a threatening person located in the unsecured area 105a or in the area 105a not having the maximum-security stage can no longer enter. The enhanced level of safety for the cockpit crew justifies and substantiates the expense for the separate entry for the cockpit crew into the aircraft, as well as for the additional door in the outer skin of the aircraft at whatever height along the longitudinal axis of the aircraft between the top of the aircraft and the security partition. As a result, once having entered the module according to the invention, the cockpit crew can pass through the entry 122 and into the rest area 103 and lavatory facilities 104, which contain storage areas 113 and a toilet or a washroom with or without toilet.

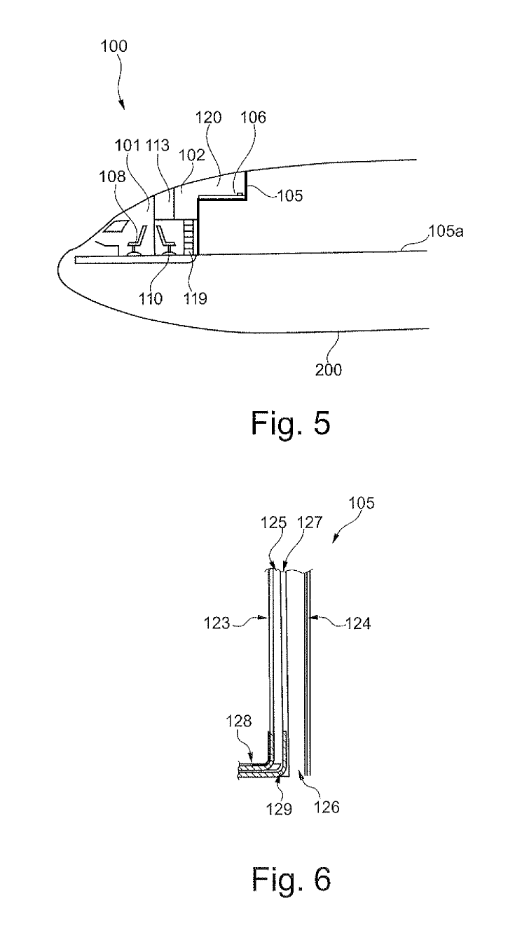

FIG. 5 shows a diagrammatic, two-dimensional sectional view along the longitudinal axis of the aircraft 200, which contains a module 100 according to the invention. This additional exemplary embodiment of the present invention shows that various elements from the lounge area or at least a component of an element from the lounge area can be arranged at a vertical height of the aircraft other than that of the work area. As clearly evident in this case, the bed option 106 lying parallel to the longitudinal axis of the aircraft is secured in the crown area of the aircraft, and in this upper area also extends into the unsecured area 105a of the aircraft 200. The security partition 105 is here designed and adapted to the contour of the module or outer skin of the module in such a way that the complete surface of the module is formed by a correspondingly designed material in terms of security. This would hence refer to both horizontally and vertically running sections of the partition. As a result, the full width, full height and full depth of the module are guaranteed to have characteristics allowing be at least one of the following: bulletproof, entry-proof, fireproof, access-proof and explosion proof. Also depicted is a climbing aid 119, which the crewmember can use to climb from a lower level where the work area 101 is located up into the berth 120 with the sleeping option 106. 113 denotes stowage compartments inside the rest area or lounge area 103. Also shown on the work level is a sitting option 110 that can be used, if necessary, to perform additional tasks that in the future can no longer be handled in the cockpit. The working area 101 also depicts a seat 108 for the pilot or copilot. This symbolically illustrates that the work area 101 realizes all the equipment necessary for steering, controlling and monitoring the aircraft.

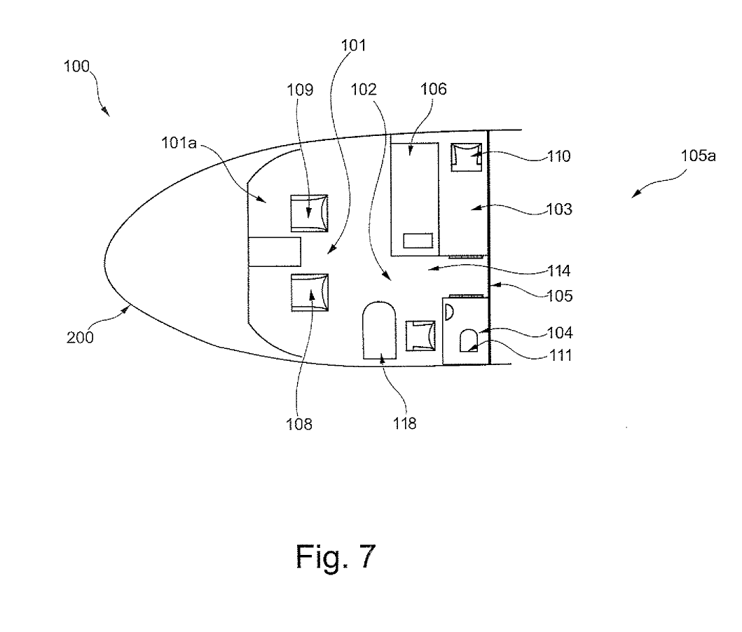

FIG. 6 shows a two-dimensional, vertical sectional view through a security partition 105, which is a significant component of the module 100 according to the invention. As clearly evident, the security partition 105 consists of a layered structure, which exhibits at least one element from the group comprised of a first decorative front plate 123, a bulletproof aramide layer 125, a hollow space 127, a honeycomb layer 126 and a second decorative front plate 124. Titanium transition elements 129 are secured at the base of the layered structure to ensure that the corners and transition element areas are bulletproof. An aluminum ceiling 128 further optically seals off horizontal section of the layered structure on the floor toward the top.

FIG. 7 shows a two-dimensional, horizontal sectional view along the longitudinal axis of an aircraft, and provides a view into the module 100 according to the invention from above. This depiction of an exemplary embodiment of the present invention demonstrates in particular that the cockpit 101a need no longer have the classic shape, and that elements including a lavatory 014, seats 110, foldable tables 118 and the elements cited further above can be fully integrated. Clearly visible as well is the security partition 105, which makes it possible to combine the work area 101 and accommodation area 102 of the cockpit crew into a single unit.

In addition, let it be noted that “comprising” does not preclude any other elements or steps, and that “an” or “a” do not rule out a plurality. Let it further be noted that features or steps that were described with reference to one of the above exemplary embodiments can also be used in combination with other features or steps from other exemplary embodiments described above. The reference numbers in the claims are not to be construed as a limitation.

### REFERENCE LIST

100 Work and accommodation module
101 Work area
101a Cockpit
102 Lounge area
103 Rest area
104 Lavatory facilities
105 Security partition
105a Unsecured area/passenger area
106 Sleeping option/bunk
108 Seat for pilot/copilot
109 Seat for pilot/copilot
110 Sitting option
111 Toilet/washroom with or without toilet
112 Partition within the module
112a Curtain
113 Storage area
114 Aisle
115 Door to the module
116 (Flight crew) rest compartment
117 Business class seat
118 Folding table
118a Table
119 Climbing aid
120 Berth
121 Entry for passengers and cabin crew
122 Exclusive entry for cockpit crew
123 Decorative front plate
124 Decorative front plate
125 Bulletproof aramide layer
126 Honeycomb layer
127 Hollow space
128 Ceiling
129 Transition element
130 Freight deck plane
200 Aircraft

1. A work and accommodation module for providing a cockpit and for accommodating at least one pilot of an aircraft, wherein the work and accommodation module comprises:
a work area and an accommodation area;
wherein the work area comprises all the equipment necessary for controlling and piloting the aircraft;
wherein the accommodation area comprises a rest area;
wherein the module is separated from the passenger area by at least one security partition; and
wherein the partition encompasses at least one of the following properties: bulletproof, entry-proof, fireproof, access-proof, and explosion proof; and
wherein the work area is arranged at a first vertical height; and
wherein the rest area comprises at least one sleeping device;
wherein the sleeping device as arranged at a second vertical height of the aircraft;
wherein the first vertical height is below the second vertical height.

2. The module of claim 1, wherein the accommodation area and/or the work area exhibit at least one climbing aid, in order to connect the work area with the accommodation area, or to connect elements of the accommodation area.

3. The module of claim 1,
wherein the rest area exhibits at least one element selected from the group comprising of a sitting device and a table.

4. The module of claim 1,
wherein the accommodation area comprises a lavatory facility.

5. The module of claim 1,
wherein the accommodation area is designed for accommodation on a freight deck plane.

6. The module of claim 1,
wherein the partition separates the module from a passenger area and is designed as a continuous wall with no door.

7. The module of claim 1,
wherein the security partition exhibits a layered structure, with the layered structure comprising of at least one element selected from the group composed of:
a first decorative front plate, a bulletproof layer, a hollow space, a honeycomb layer, a second decorative front plate, a bulletproof transition element and a ceiling for the transition element.

8. The module of claim 1,
wherein an interior of the module is divided into compartments by spatial partition elements, such as curtains, partition walls, room dividers, folding walls, partition screens, partition wall systems, room partition walls, cabins, partition wall units or blinds.

9. (canceled)

10. An aircraft with a work and accommodation module, wherein the module comprises:
a work area and an accommodation area;
wherein the work area comprises all the equipment necessary for controlling and piloting the aircraft;
wherein the accommodation area comprises a rest area;
wherein the module is separated from the passenger area by at least one security partition; and
wherein the partition encompasses at least one of the following properties: bulletproof, entry-proof, fireproof, access-proof, and explosion proof; and
wherein the work area is arranged at a first vertical height; and
wherein the rest area comprises at least one sleeping device;
wherein the sleeping device as arranged at a second vertical height of the aircraft;
wherein the first vertical height is below the second vertical height.
